(19) United States
(12) Patent Application Publication
(10) Pub. No.: US 2003/0120368 A1
(43) Pub. Date: Jun. 26, 2003

(54) Method and apparatus for providing audio clips to enhance the user interface of a set-top terminal

(76) Inventor: Richard T. Walsh, Marlton, NJ (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/357,584

(22) Filed: Feb. 3, 2003

Related U.S. Application Data
(62) Division of application No. 09/088,493, filed on Jun. 2, 1998.

(51) Int. Cl. G06F 17/00

(52) U.S. Cl. 700/94

(57) ABSTRACT

An enhanced user interface for a set-top terminal allows audio recordings or sound clips to be played in response to system events occurring within the set-top terminal. The set-top terminal includes a memory unit in which digital audio recordings are stored and a processor for retrieving the recordings and audibilizing the recordings in response to system events such as powering up the set-top terminal, requesting a menu display, or making a selection from the menu.

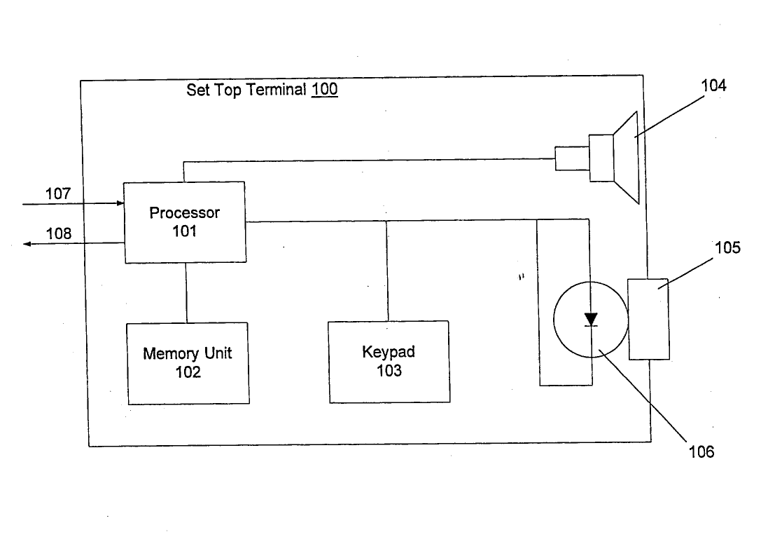

### FIELD OF THE INVENTION

The present invention relates to the field of cable and satellite television. More particularly, the present invention relates to a method and apparatus for providing sounds and audio clips to enhance the user interface of a set-top terminal which is part of a cable or satellite television system.

### BACKGROUND OF THE INVENTION

Cable and satellite television systems are becoming increasingly popular in modern society and provide viewers with a vast array of channels and available programming for education and entertainment. The drawbacks of such television systems reside in the expense and need for additional equipment. For example, many cable and satellite television systems require a set-top terminal be attached to the viewer's television.

A set-top terminal is a small box of electronic equipment which is used in conjunction with a viewer's television to control and implement a cable or satellite television system. The set-top terminal typically receives a broadcast television signal from the cable or satellite system and provides the signal to the television. The set-top terminal may include circuitry to unscramble premium channels in the system and generally makes reception of the system's signals possible. A set-top terminal may be controlled through a small keypad on the terminal itself, or through a remote control unit.

Some viewers can become frustrated with the proliferation of electronic equipment attached to their television sets including such set-top terminals. Accordingly, there is a need in the art for a means to make the user interface with the set-top terminal more friendly and attractive to viewers.

### SUMMARY OF THE INVENTION

It is an object of the present invention to meet the above-described needs and others. Specifically, it is an object of the present invention to provide a method and apparatus to make the user interface with the set-top terminal more friendly and attractive to viewers.

Additional objects, advantages and novel features of the invention will be set forth in the description which follows or may be learned by those skilled in the art through reading these materials or practicing the invention. The objects and advantages of the invention may be achieved through the means recited in the attached claims.

To achieve the objects of the present invention, the invention may be embodied as a set-top terminal with an enhanced user interface which includes a memory unit in which at least one audio recording is stored; and a processor connected to the memory unit. The set-top terminal may further include a speaker on which an audio recording is played by the processor. The processor accesses the memory unit and plays an audio recording stored therein in response to a system event, such as receipt of user input.

Particularly, the set-top terminal may include a user input device for providing user input to the processor. The processor then plays an audio recording from the memory unit in response to the user input from the user input device. The user input device may be a keypad on the set-top terminal or a photodetector in the set-top terminal for receiving an optical signal for a remote control unit.

Preferably, the present invention includes a terminal connected to the processor through which a signal is received by the processor. The signal may provide audio data which is recorded by the processor in the memory unit. Also a terminal may be provided for connecting the processor to a television.

The present invention also encompasses a method of enhancing a user interface with a set-top terminal. Stated succinctly, the method of the present invention includes audibilizing an audio recording in response to a system event occurring within the set-top terminal.

However, the specific steps of the present invention may include: storing at least one audio recording in a memory unit; accessing the memory unit with a processor to retrieve an audio recording for playback in response to the system event; and receiving user input from a user input device, the system event being initiated by the user input.

To store new audio recordings, the method of the present invention may include: receiving a signal through a terminal connected to the processor, the signal providing audio data; and recording the audio data in the memory unit with the processor.

To enhance the flexibility of the user interface, the method of the present invention may also include receiving user input which associates a particular audio recording in the memory unit with a particular system event such that the particular audio recording is accessed by the processor for playback in response to the particular system event.

### BRIEF DESCRIPTION OF THE DRAWINGS

The accompanying drawing illustrates the present invention and is a part of the specification. Together with the following description, the drawing demonstrates and explains the principles of the present invention.

The FIGURE is a block diagram of a set-top terminal according to the principles of the present invention.

### DETAILED DESCRIPTION OF THE PREFERRED EMBODIMENTS

Using the drawings, the preferred embodiments of the present invention will now be explained. As shown in the FIGURE, the present invention may be embodied as a set-top terminal 100 capable of audibilizing audio clips as part of a user interface.

The exemplary set-top terminal 100 shown in the FIGURE includes a processor 101 and a memory unit 102. The memory unit 102 stores digital audio recordings which can be accessed by the processor 101 for use in the user interface.

The user may interface with the set-top box 101 in a variety of equivalent ways. As shown in the FIGURE, the set-top box 101 may include a window 105 behind which a photodetector 106, such as a photodiode, is positioned. The photodetector 106 may then receive an optical signal through the window 105 from a remote control unit (not shown). This optical signal may provide user input to the set-top terminal 100. Alternatively and equivalently, a remote control unit might transmit a radio-frequency signal which is received by an antenna in the set-top box.

As another alternative, the set-top box 101 may include a keypad 103 located on the set-top box 101. A user may use the keypad 103 to enter input into the set-top box.

Once the user has interfaced with the set-top box 101 through any of the means described above, or through any other means of providing user input, the input is received by the processor 101. The processor 101 responds to the user input according to its programming. For example, the user input may instruct the processor 101 to change the channel being shown a television (not shown) to which the set-top terminal 100 is connected. The connection between the television and the set-top box 100 is provided through terminal 108. Additionally, the processor 101 receives input from a cable or satellite television system through terminal 107.

As part of its response to the user input, the processor 101 will also retrieve a digital audio recording from the memory unit 102 and audibilize that recording. For example, the set-top box 100 may include a speaker 104 over which the digital audio recording could be played. Alternatively, the processor 101 may use the connection 108 to the television to play an audio recording from memory 102 over the speaker of the television (not shown).

Different audio recordings may be associated with particular types of user input. For example, when the user first turns on the set-top terminal 100, a “greeting” recording may be played by the processor 101. The greeting could be a recorded verbal greeting, a particular noise or any other recording.

More particularly, under the principles of the present invention, the processor 101 may be running a piece of software that acts as a “sound server.” The server will maintain a list of the pre-recorded audio clips available in the memory unit 102 which can be associated with system events. For example, if the set-top uses a menu system to display options to the user, a specific sound can be played whenever the user signals the set-top terminal 100 to display the menu.

Preferably, the processor 101 and memory unit 102 will be designed to playback at least the two most common format for digital sound recordings, GI sound and Microsoft Wave (.WAV). The GI sound format is typically used for simple sounds such as clicks and beeps while the Wave format allows complex sounds from numerous sources to be played.

The processor 101 can be programmed to automatically fetch the next piece of data for playback from the memory unit 102 thus providing a “streaming function” that enables longer audio clips to be played. Each audio recording in the memory unit 102 may be up to 64K in length. Additionally, the processor 101 can provide anti-alias filtering, volume control and multiple sampling rates for Wave sound data.

Additionally, the user may be allowed, through the various user input devices described and their equivalents, to select the audio recording that is to be associated with particular system events and to program the processor 101 to play that audio recording in response to the specified system event.

Digital audio recordings may be provided to the processor 101 and the memory unit 102 in a variety of ways. Some recordings may be placed in the memory unit 102 as defaults. Additionally, the terminal 107 through which the processor 101 connects to a service provider's system may supply audio recordings. For example, the processor 101 and the set-top terminal 100 may support browsing of the World Wide Web. Therefore, audio recordings may be downloaded from the Web and stored in the memory unit 102. Alternatively, the set-top terminal 100 may have other ports which allow a user to interface the processor 101 with, for example, a compact disk player, and obtain sound recordings from a compact disk.

The preceding description has been presented only to illustrate and describe the invention. It is not intended to be exhaustive or to limit the invention to any precise form disclosed. Many modifications and variations are possible in light of the above teaching.

The preferred embodiment was-chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A set-top terminal with an enhanced user interface, comprising:
a memory unit in which at least one audio recording is stored; and
a processor connected to said memory unit;
wherein said processor accesses said memory unit and plays an audio recording stored therein in response to a system event.

2. A set-top terminal as claimed in claim 1, further comprising a user input device for providing user input to said processor, wherein said processor plays an audio recording from said memory unit in response to said user input from said user input device.

3. A set-top terminal as claimed in claim 2, wherein said user input device is a keypad.

4. A set-top terminal as claimed in claim 2, wherein said user input device is a photodetector for receiving an optical signal.

5. A set-top terminal as claimed in claim 1, further comprising a speaker on which an audio recording is played by said processor.

6. A set-top terminal as claimed in claim 1, further comprising a terminal connected to said processor through which a signal is received, said signal providing audio data which is recorded by said processor in said memory unit.

7. A set-top terminal as claimed in claim 1, further comprising a terminal for connecting said processor to a television.

8. A method of enhancing a user interface with a set-top terminal, comprising audibilizing an audio recording in response to a system event occurring within said set-top terminal.

9. A method as claimed in claim 8, further comprising:
storing at least one audio recording in a memory unit; and
accessing said memory unit with a processor to retrieve an audio recording for playback in response to said system event.

10. A method as claimed in claim 8, further comprising receiving user input from a user input device, wherein said system event is initiated by said user input.

11. A method as claimed in claim 8, wherein said audibilizing is accomplished with a speaker provided in said set-top terminal.

12. A method as claimed in claim 8, further comprising:
receiving a signal through a terminal connected to said processor, said signal providing audio data; and
recording said audio data in said memory unit with said processor.

13. A method as claimed in claim 8, further comprising receiving, with said processor, user input which associates a particular audio recording in said memory unit with a particular system event such that said particular audio recording is accessed by said processor for playback in response to said particular system event.
